(19) United States
(12) Patent Application Publication
(10) Pub. No.: US 2012/0180948 A1
(43) Pub. Date: Jul. 19, 2012

(54) METHOD FOR CONTROLLING THE DEPOSITION OF GRANULES ON AN ASPHALT-COATED SHEET

(75) Inventor: David P. Aschenbeck, Newark, OH (US)

(73) Assignee: OWENS CORNING INTELLECTUAL CAPITAL, LLC, Toledo, OH (US)

(21) Appl. No.: 13/005,562

(22) Filed: Jan. 13, 2011

(51) Int. Cl. B32B 38/04

(52) U.S. Cl. 156/269

(57) ABSTRACT

A method of making shingles that have an overlay portion and an underlay portion includes establishing a continuous shingle overlay sheet having a repeated pattern of tabs and cutouts. A continuous shingle underlay sheet having a repeated pattern of granule patches is also established. The presence of the pattern of tabs and cutouts on the continuous shingle overlay sheet is sensed and the presence of the pattern of granule patches on the continuous shingle underlay sheet is also sensed. The position of the continuous shingle overlay sheet relative to the continuous shingle underlay sheet is synchronized in response to the sensed presence of the repeated pattern of tabs and cutouts and the sensed presence of the repeated pattern of granule patches. Each granule patch in the pattern of granule patches is then aligned with one of the tabs in the pattern of tabs and cutouts. The continuous shingle overlay sheet is laminated to the continuous shingle underlay sheet to define a laminated sheet, and the laminated sheet is cut into a plurality of shingles.

### BACKGROUND

This invention relates to asphalt-based roofing materials. More particularly, this invention relates to methods for controlling the deposition of granules from a granule applicator onto an asphalt-coated sheet. Asphalt-based roofing materials, such as roofing shingles, roll roofing and commercial roofing, are installed on the roofs of buildings to provide protection from the elements, and to give the roof an aesthetically pleasing look. Typically, the roofing material is constructed of a substrate such as a glass fiber mat or an organic felt, an asphalt coating on the substrate, and a surface layer of granules embedded in the asphalt coating.

A common method for the manufacture of asphalt shingles is the production of a continuous sheet of asphalt material followed by a shingle cutting operation which cuts the material into individual shingles. In the production of asphalt sheet material, either a glass fiber mat or an organic felt mat is passed through a coater containing hot liquid asphalt to form a tacky, asphalt-coated sheet. Subsequently, the hot asphalt-coated sheet is passed beneath one or more granule applicators which discharge protective and decorative surface granules onto portions of the asphalt sheet material.

In the manufacture of colored shingles, two types of granules are typically employed. Headlap granules are granules of relatively low cost used for the portion of the shingle which will be covered up on the roof. Colored granules or prime granules are of relatively higher cost and are applied to the portion of the shingle that will be exposed on the roof.

To provide a visible color pattern of pleasing appearance, the colored portion of the shingles may be provided with areas of different colors. Usually the shingles have a background color and a series of granule deposits of different colors or different shades of the background color. A common method for manufacturing the shingles is to discharge blend drops onto spaced areas of the tacky, asphalt-coated sheet. Background granules are then discharged onto the sheet and adhere to the tacky, asphalt-coated areas of the sheet between the granule deposits formed by the blend drops. The term “blend drop,” as used herein, refers to the flow of granules of different colors or different shades of color (with respect to the background color) that is discharged from a granule blend drop applicator onto the asphalt-coated sheet. The patch or assemblage of the blend drop granules on the asphalt-coated sheet is also referred to as the “blend drop.”

One of the problems with conventional granule application methods for manufacturing laminated shingles is that the underlay will be covered by relatively more expensive prime granules. In such conventional methods for manufacturing laminated shingles, even the portions of the underlay that will be covered by the tabs of the overlay are covered with prime granules.

A known granule depositing method is shown in U.S. Pat. No. 5,795,389 issued to Koschitzky, which is hereby incorporated by reference in its entirety. The Koschitzky reference discloses a method of depositing a pattern of sharply demarked granule patches on the visible surface of a shingle. The Koschitzky reference further discloses an auxiliary belt onto which a series of patches of granules is deposited. The auxiliary belt is positioned above the asphalt-coated sheet, and includes an upper flight and a lower flight, with the upper flight travelling in a direction opposite that of the asphalt-coated sheet. At the upstream end of the auxiliary belt (i.e., upstream with respect to the movement of the asphalt-coated sheet) the upper flight of the auxiliary belt turns around a belt roller to form the lower flight. A retaining conveyor is wrapped around the upstream end of the auxiliary conveyor to keep the granules from flying about as the granules are turned into a downward direction. The granules of each of the patches are dropped vertically straight down onto the asphalt-coated sheet to form blend drops. After the blend drops are applied to the asphalt-coated sheet the background granules are applied to form a granule-coated sheet, which is then cooled and cut into individual granule-coated shingles.

U.S. Pat. No. 5,814,369 to Bockh et al. discloses another blend drop granule applicator having an applicator roll positioned to rotate directly above a moving asphalt-coated sheet. The applicator deposits a pattern of granule patches or blend drops on the visible surface of a shingle. The Bockh et al. reference is hereby incorporated by reference in its entirety. Granules corresponding to a desired blend drop are deposited onto the applicator roll at the top of the rotation, and when the applicator roll rotates approximately 162 degrees the blend drop falls off onto the asphalt-coated sheet when the blend drop reaches the bottom of the rotation. A media retaining belt engages the applicator roll, contacting and wrapping around the applicator roll to hold the blend drop granules on the surface of the applicator roll until the applicator roll rotates about 162 degrees. At the point where the media retaining belt stops contacting or becomes disengaged from the applicator roll, the blend drop granules are released to drop onto the moving asphalt-coated sheet to form the blend drop. The Bockh et al. patent states that the distance that the granules fall from the applicator roll to the asphalt-coated sheet should be minimized. The Bockh et al. patent further states that the linear velocity of the applicator roll should be synchronized with that of the moving asphalt-coated sheet so that the granules can be dropped precisely in the desired pattern.

The concurrently filed U.S. patent application entitled “Apparatus and Method for Depositing Particles” (U.S. patent application Ser. No. ______) to David P. Aschenbeck discloses a method and a granule applicator for applying granules onto an asphalt-coated sheet. The granule applicator includes a rotating member having a body defining an interior space and an axis of rotation. A granule outlet opening is formed in the body and connects the interior space and an exterior of the rotating member. The granule outlet opening further defines a granule bin in the body of the rotating member. A granule dispenser is mounted within the interior space of the body of the rotating member and is connected to a source of granules. A belt engages a first portion of an outer circumferential surface of the body of the rotating member. As the rotating member rotates about its axis of rotation, the granule outlet opening moves between a closed position wherein the granule outlet opening is closed by the belt, and an open position wherein the granule outlet opening is uncovered. U.S. patent application Ser. No. ______ is commonly assigned, has the same inventor as the present application, and is incorporated herein by reference.

The above notwithstanding, there remains a need in the art for an improved method of making shingles having an overlay portion and an underlay portion.

### SUMMARY OF THE INVENTION

The present application describes various embodiments of a method of making shingles. In one embodiment, the method of making shingles that have an overlay portion and an underlay portion includes establishing a continuous shingle overlay sheet having a repeated pattern of tabs and cutouts. A continuous shingle underlay sheet having a repeated pattern of granule patches is also established. The presence of the pattern of tabs and cutouts on the continuous shingle overlay sheet is sensed and the presence of the pattern of granule patches on the continuous shingle underlay sheet is also sensed. The position of the continuous shingle overlay sheet relative to the continuous shingle underlay sheet is synchronized in response to the sensed presence of the repeated pattern of tabs and cutouts and the sensed presence of the repeated pattern of granule patches. Each granule patch in the pattern of granule patches is then aligned with one of the tabs in the pattern of tabs and cutouts. The continuous shingle overlay sheet is laminated to the continuous shingle underlay sheet to define a laminated sheet, and the laminated sheet is cut into a plurality of shingles.

In another embodiment, a method of making shingles that have an overlay portion and an underlay portion includes establishing a continuous asphalt-coated sheet having a continuous underlay sheet portion and a continuous underlay sheet portion. A repeated pattern of granule patches is applied to the continuous underlay sheet portion. A repeated pattern of tabs and cutouts is formed in the continuous overlay sheet portion. The continuous underlay sheet portion is separated from the continuous overlay sheet portion to define a continuous shingle underlay sheet and a continuous shingle overlay sheet. The presence of the pattern of tabs and cutouts on the continuous shingle overlay sheet is sensed. The presence of the pattern of granule patches on the continuous shingle underlay sheet is sensed. The position of the continuous shingle overlay sheet is synchronized relative to the continuous shingle underlay sheet in response to the sensed presence of the repeated pattern of tabs and cutouts and the sensed presence of the repeated pattern of granule patches. Each granule patch in the pattern of granule patches is then aligned with one of the tabs in the pattern of tabs and cutouts. The continuous shingle overlay sheet is laminated to the continuous shingle underlay sheet to define a laminated sheet, and the laminated sheet is cut into a plurality of shingles.

Other advantages of the method of making shingles will become apparent to those skilled in the art from the following detailed description, when read in light of the accompanying drawings.

### BRIEF DESCRIPTION OF THE DRAWINGS

A complete appreciation of the invention and the many embodiments thereof will be readily obtained as the same becomes better understood by reference to the following detailed description when considered in connection with the accompanying drawings, wherein:

FIG. 1 is a schematic view in elevation of an apparatus for manufacturing an asphalt-based roofing material according to the invention.

FIG. 2 is a plan view of a portion of the apparatus illustrated in FIG. 1, showing the laminating of the continuous underlay sheet beneath the continuous overlay sheet to make shingle overlay to form a continuous laminated sheet.

FIG. 3A is an exploded schematic perspective view of a laminated shingle manufactured in the apparatus illustrated in FIG. 1.

FIG. 3B is a schematic plan view of the laminated shingle illustrated in FIG. 3A.

FIG. 4 is an enlarged schematic view in elevation of the first granule applicator illustrated in FIG. 1.

FIG. 5 is a plan view of a portion of the continuous belt illustrated in FIG. 1, showing the pattern of holes.

### DETAILED DESCRIPTION

The present invention will now be described with occasional reference to the illustrated embodiments of the invention. This invention may, however, be embodied in different forms and should not be construed as limited to the embodiments set forth herein, nor in any order of preference. Rather, these embodiments are provided so that this disclosure will be more thorough, and will convey the scope of the invention to those skilled in the art.

Unless otherwise defined, all technical and scientific terms used herein have the same meaning as commonly understood by one of ordinary skill in the art to which this invention belongs. The terminology used in the description of the invention herein is for describing particular embodiments only and is not intended to be limiting of the invention. As used in the description of the invention and the appended claims, the singular forms “a,” “an,” and “the” are intended to include the plural forms as well, unless the context clearly indicates otherwise.

Unless otherwise indicated, all numbers expressing quantities of ingredients, properties such as molecular weight, reaction conditions, and so forth as used in the specification and claims are to be understood as being modified in all instances by the term “about.” Accordingly, unless otherwise indicated, the numerical properties set forth in the specification and claims are approximations that may vary depending on the desired properties sought to be obtained in embodiments of the present invention. Notwithstanding that the numerical ranges and parameters setting forth the broad scope of the invention are approximations, the numerical values set forth in the specific examples are reported as precisely as possible. Any numerical values, however, inherently contain certain errors necessarily resulting from error found in their respective measurements.

As used in the description and the appended claims, the phrase “asphalt coating” is defined as any type of bituminous material suitable for use on a roofing material, such as asphalts, tars, pitches, or mixtures thereof. The asphalt may be either manufactured asphalt produced by refining petroleum or naturally occurring asphalt. The asphalt coating may include various additives and/or modifiers, such as inorganic fillers or mineral stabilizers, organic materials such as polymers, recycled streams, or ground tire rubber. Preferably, the asphalt coating contains asphalt and an inorganic filler or mineral stabilizer.

As used in the description of the invention and the appended claims, the term “period” is defined as the completion of a cycle.

Laminated composite shingles, such as asphalt shingles, are a commonly used roofing product. Asphalt shingle production generally includes feeding a base material from an upstream roll and coating it first with a roofing asphalt material, then a layer of granules. The base material is typically made from a fiberglass mat provided in a continuous shingle membrane or sheet. It should be understood that the base material can be any suitable support material.

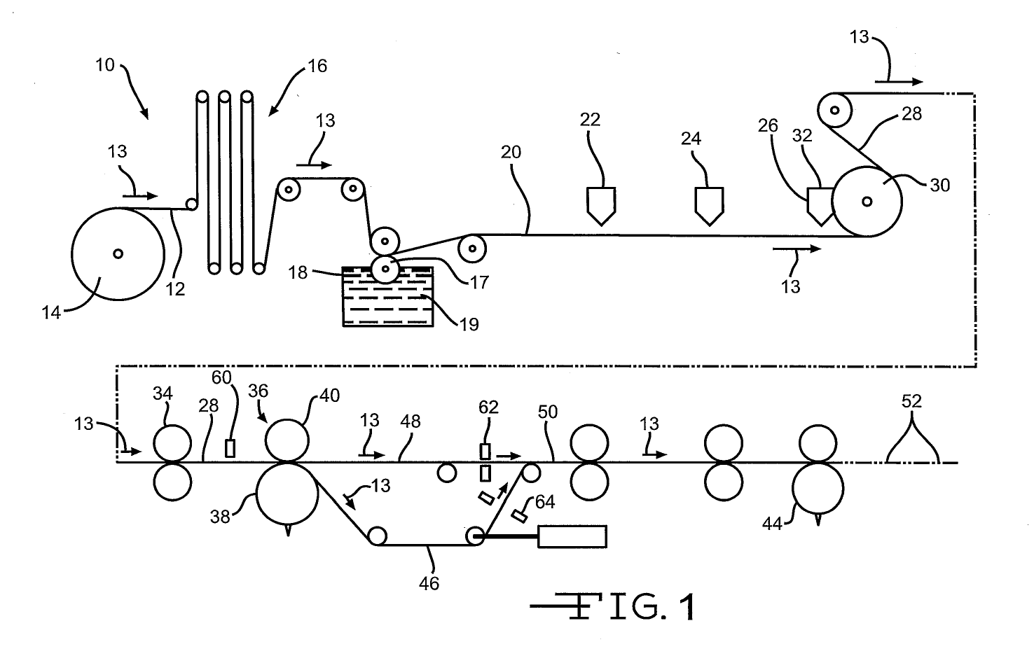

Referring now to the drawings, there is shown in FIG. 1 an apparatus 10 for manufacturing an asphalt-based roofing material, and more particularly for applying granules onto an asphalt-coated sheet. The illustrated manufacturing process involves passing a continuous sheet of substrate or shingle mat 12 in a machine direction 13 through a series of manufacturing operations. The sheet usually moves at a speed of at least about 200 feet/minute (61 meters/minute), and typically at a speed within the range of between about 450 feet/minute (137 meters/minute) and about 620 feet/minute (244 meters/minute). However, other speeds may be used.

In a first step of the manufacturing process, the continuous sheet of shingle mat 12 is payed out from a roll 14. The shingle mat 12 may be any type known for use in reinforcing asphalt-based roofing materials, such as a nonwoven web of glass fibers. Alternatively, the substrate may be a scrim or felt of fibrous materials such as mineral fibers, cellulose fibers, rag fibers, mixtures of mineral and synthetic fibers, or the like.

The sheet of shingle mat 12 is passed from the roll 14 through an accumulator 16. The accumulator 16 allows time for splicing one roll 14 of substrate to another, during which time the shingle mat 12 within the accumulator 16 is fed to the manufacturing process so that the splicing does not interrupt manufacturing.

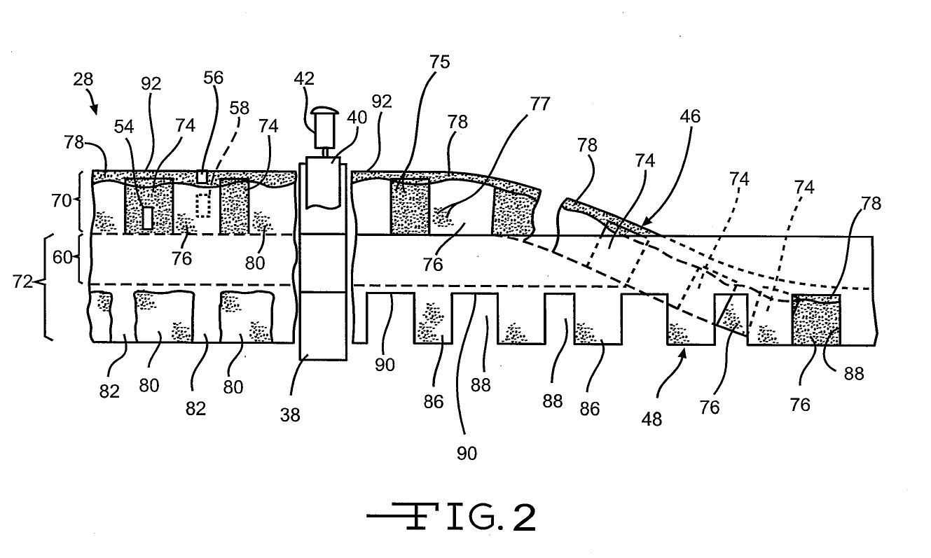

Next, the shingle mat 12 is passed through a coater 18 where a coating of hot, melted asphalt 19 is applied to the shingle mat 12 to form an asphalt-coated sheet 20. The asphalt coating 19 may be applied in any suitable manner. In the illustrated embodiment, the shingle mat 12 contacts a roller 17, which is in contact with the supply of hot, melted asphalt 19. The roller 17 completely covers the shingle mat 12 with a tacky coating of asphalt 19. However, in other embodiments, the asphalt coating 19 could be sprayed on, rolled on, or applied to the shingle mat 12 by other means. Typically the asphalt coating is highly filled with a ground mineral filler material, amounting to at least about 42 percent by weight of the asphalt/filler combination. In one embodiment, the asphalt coating 19 is in a range from about 350° F. to about 400° F. In another embodiment, the asphalt coating 19 may be more than 400° F. or less than 350° F. The shingle mat 12 exits the coater 18 as an asphalt-coated sheet 20. The asphalt coating 19 on the asphalt-coated sheet 20 remains hot. The asphalt-coated sheet 20 includes a continuous underlay sheet portion 70 and a continuous overlay sheet portion 72, as best shown in FIG. 2 and described in detail below.

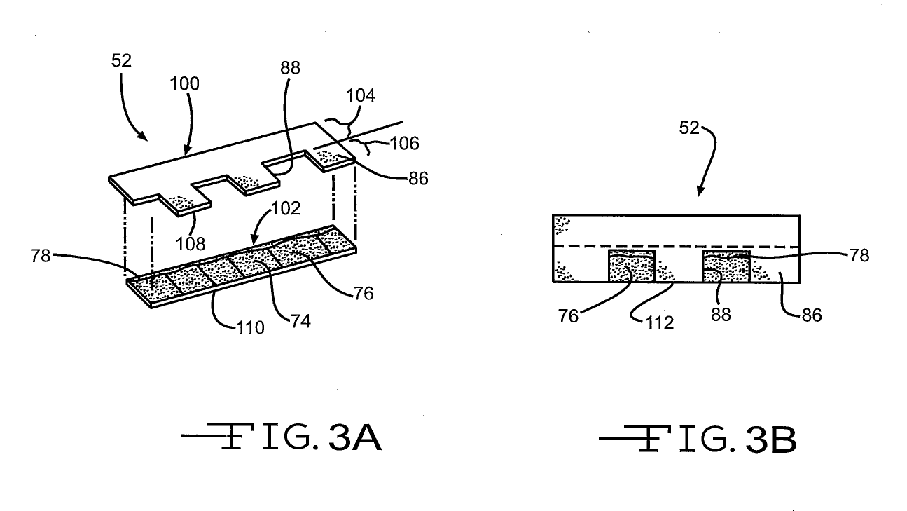

The asphalt-coated sheet 20 is passed beneath a first granule applicator, shown schematically at 22, where a repeated pattern of granule patches 74 is applied to the continuous underlay sheet portion 70 of the asphalt-coated sheet 20. The patches 74 of the repeated pattern of granule patches 74 correspond to the shapes and sizes of the repeated pattern of tabs 86 of a finished laminated shingle 52, as shown in FIGS. 3A and 3B. The patches 74 will be underneath the tabs 86, and will not be visible in the finished laminated shingle 52. Advantageously, relatively less expensive first or headlap granules 75 may be used to form the repeated pattern of granule patches 74. A shadow strip 78 is formed along an edge 92 (the upper edge when viewing FIG. 2) of the continuous underlay sheet portion 70, and will be described in detail below. The portion of the continuous underlay sheet portion 70 not covered by the patches 74 and the shadow strip 78 defines a prime region 76. The prime region 76 will be visible through the cutouts 88 of the finished laminated shingle 52.

The asphalt-coated sheet 20 is then passed beneath a second granule applicator. In the illustrated embodiment, the second granule applicator is a blend drop applicator, shown schematically at 24. The blend droop applicator 24 applies second or blend drop granules 77 to the continuous overlay sheet portion 72 of the asphalt-coated sheet 20 to define blend drops 80. Although only one blend drop applicator 24 is shown, it will be understood that several blend drop applicators 24 may be used. Alternatively, the blend drop applicator 24 may be adapted to supply several streams of blend drops, or blend drops of different colors, shading, or size to the continuous overlay sheet portion 72. The blend drop applicator 24 also applies blend drop granules to the prime region 76 of the continuous underlay sheet portion 70 of the asphalt-coated sheet 20.

The asphalt-coated sheet 20 is then passed beneath a third granule applicator. In the illustrated embodiment, the third granule applicator is a backfall granule applicator 26, for applying additional granules, such as shadow granules to the shadow strip 78, background granules, and headlap granules onto the asphalt-coated sheet 20.

The shadow granules are deposited along the edge 92 (the upper edge when viewing FIG. 2) of the continuous underlay sheet portion 70 and define the shadow strip 78. A portion of the shadow strip 78 will be visible adjacent an upper edge 90 of the cutout 88 of the laminated shingle 52. The background granules are applied to the continuous overlay sheet portion 72 and adhere to a remainder portion 82; i.e., the portion of the continuous overlay sheet portion 72 of the asphalt-coated sheet 20 that is not already covered by the blend drops 80. Similarly, the headlap granules are applied to a headlap region 60 of the continuous overlay sheet portion 72.

The background granules are applied to the extent that the asphalt-coated sheet 20 becomes completely covered with granules, thereby defining a continuous granule-coated sheet 28. The granule-coated sheet 28 is then turned around a slate drum 30 to press the granules into the asphalt coating and to temporarily invert the sheet 28. Such inverting of the granule-coated sheet 28 causes any excess granules to drop off the granule-coated sheet 28 on the backside of the slate drum 30. The excess granules are collected by a hopper 32 of the backfall granule applicator 26 and may be reused. As described below, the hopper 32 is positioned on the backside of the slate drum 30.

The continuous granule-coated sheet 28 is fed through pull rolls 34 that regulate the speed of the sheet 28 as it moves downstream. In one embodiment, at least one of the pull rolls 34 is driven by a motor (not shown).

The granule-coated sheet 28 is subsequently fed through a rotary pattern cutter 36 which includes a bladed cutting cylinder 38, a backup roll 40, and a motor 42, as shown in FIG. 2. The pattern cutter 36 cuts a repeated pattern of tabs 86 and cutouts 88. It will be understood that the tabs 62 may have any desired combination of color blend drops.

The pattern cutter 36 also cuts the granule-coated sheet 28 into the continuous underlay sheet 46 and the continuous overlay sheet 48. As shown in FIG. 2, the continuous underlay sheet 46 is directed to be aligned beneath the continuous overlay sheet 48, and the two sheets 46, 48 are laminated together to form a continuous laminated sheet 50. As shown in FIG. 1, the continuous underlay sheet 46 is routed on a longer path than the path of the continuous overlay sheet 48. Further downstream, the continuous laminated sheet 50 is passed into contact with a rotary length cutter 44 that cuts the laminated sheet 50 into individual laminated shingles 52.

To facilitate synchronization of the cutting and laminating steps, various sensors and controls can be employed, as disclosed in U.S. Pat. No. 6,635,140 to Phillips et al., the disclosure of which is incorporated herein by reference. For example, a timing mark as known in the art and indicating the period of the repeated pattern of granule patches 74 may be applied to an appropriate part of the granule-coated sheet 28.

In one embodiment, the timing mark may be applied within a patch 74, as shown at 54. In another embodiment, the timing mark may be applied within the shadow strip 78, as shown at 56. In another embodiment, the timing mark may be applied on a back side of the continuous underlay sheet portion 70, as shown by the dashed line 58. Any of the illustrated embodiments of the timing mark 54, 56, 58 may be used for synchronization in a known manner. The timing mark 54, 56, 58 may be applied by any means, and may be a relatively thin blend drop of granules applied by a blender 24 or a timing mark blender (not shown). The timing mark 54, 56, 58 may comprise white colored granules. Alternatively, the timing mark 54, 56, 58 may also be any suitable light-colored material, such as paint, chalk, or the like. The timing may be sensed by a sensor, such as a photoeye 60, for synchronization with the rotating rotary pattern cutter 36.

Additionally, sensors, such as photoeyes 62 and 64 may be used to synchronize the pattern of granule patches 74 of the continuous shingle underlay sheet 46 with the tabs 86 of the continuous shingle overlay sheet 48. Such synchronization ensures that each granule patch 64 of the continuous shingle underlay sheet 46 is aligned with one of the tabs 86 of the continuous shingle overlay sheet 48. As used herein and the appended claims, the phase “aligned with” is defined as the shapes and sizes of the granule patches 74 in the repeated pattern of granule patches 74 corresponding to the shapes and sizes of the repeated pattern of tabs 86, such that the granule patches 74 are covered by the tabs 86 and only the prime granules of the prime region 76 are visible through the cutouts 88. Advantageously, by synchronizing and aligning each granule patch 64 of the continuous shingle underlay sheet 46 with one of the tabs 86 of the continuous shingle overlay sheet 48, the relatively more expensive prime granules are needed only for the prime region 76 of the continuous shingle underlay sheet 46 that will be visible through the cutouts 88 of the laminated shingle 52. The relatively less expensive headlap granules may be used to form the pattern of granule patches 74 of the continuous underlay sheet 46. The cost of the shingle is therefore reduced.

As shown in FIGS. 3A and 3B, a laminated shingle 52 formed by the process illustrated in FIGS. 1 and 2 may include an overlay sheet 100 and an underlay sheet 102. The overlay sheet 100 includes an upper or headlap portion 104, and a lower prime or butt portion 106. The butt portion 106 includes a repeated pattern of the tabs 86 and cutouts 88. A rear surface of the overlay sheet 100 and a front surface of the underlay sheet 102 are fixedly attached to each other to form the laminated shingle 52. Such attachment can be accomplished by using adhesive materials applied to the rear surface of the overlay sheet 100 and the front surface of the underlay sheet 102. In the illustrated embodiment, a butt edge 108 of the butt portion 106 of the overlay sheet 100 and a lower edge 110 of the underlay sheet 102 are vertically aligned to define a lower edge 112 of the shingle 52. If desired, a bead of adhesive (not shown) may be applied to a bottom surface of the underlay sheet 102. Although FIGS. 3A and 3B illustrate a laminated shingle, it will be understood that the method and apparatus of the invention may be used with single layer shingles, such as three-tab shingles.

The granules deposited on the composite material shield the roofing asphalt material from direct sunlight, offer resistance to fire, and provide texture and color to the shingle. The headlap portions 104 may be ultimately covered by adjacent shingles 52 when installed upon a roof. When installed upon a roof, the granule patches 74 of the underlay sheet 102 will be covered by the tabs 86, and the prime regions 76 of the underlay sheet 102 will be visible through the cutouts 88. Prime granules are therefore used on the prime regions 76 of the underlay sheet 102 so that the underlay sheet 102 visible through the cutouts 88 always contains prime granules.

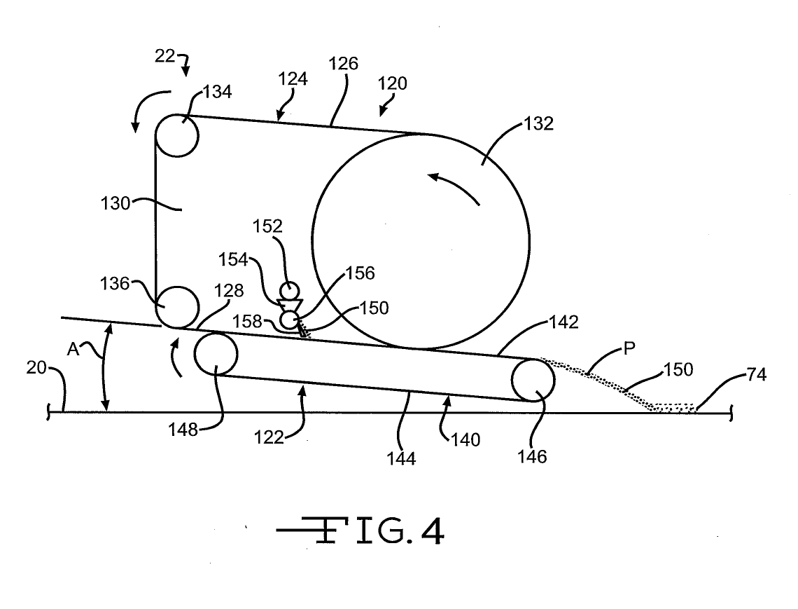

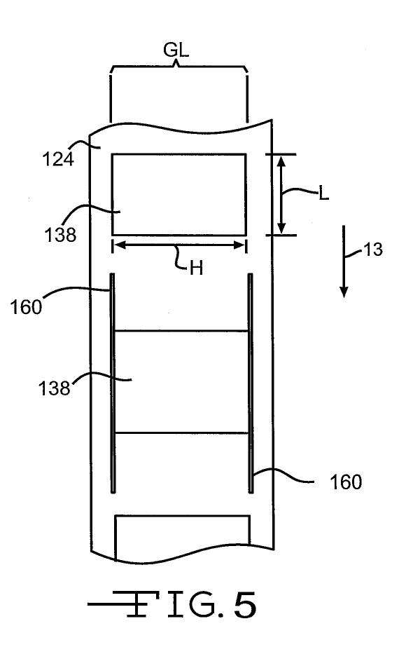

Referring now to FIGS. 4 and 5, a first embodiment of the first granule applicator is shown generally at 22. The first granule applicator 22 includes a patch pattern belt assembly 120 and a granule patch conveyor 122.

As shown schematically in FIG. 4, the patch pattern belt assembly 120 includes a continuous belt 124 having an upper flight 126, a lower flight 128, and defining an interior space 130. The belt 124 travels around a first or forward large roller 132, an upper rear roller 134, and a lower rear roller 136. The patch pattern belt assembly 120 is operated by a motor (not shown) which causes the continuous belt 124 to travel at near machine speed, or the speed of the moving asphalt-coated sheet 20. In the illustrated embodiment, the upper rear roller 134 is mounted upwardly and forwardly (to the right when viewing FIG. 4) of the lower rear roller 136.

The continuous belt 124 includes a plurality of holes 138 forming a pattern of holes 138. The repeating pattern of holes 138 corresponds to the desired pattern of granule patches 74. Each hole 138 has a length L, measured in the machine direction 13, and a height H, equal to the length and height, respectively, of the granule patch 74 to be applied to the asphalt-coated sheet 20. The illustrated holes 138 have a rectangular shape. It will be understood however, that the holes 138 may have any other desired shape corresponding to a desired shape of the granule patches 74.

In the illustrated embodiment, the length of the continuous belt 124 is equal to the circumference of the pattern cutter 36. Alternatively, the continuous belt 124 may have other lengths, such as a length smaller than the circumference of the pattern cutter 36, or a length larger than the circumference of the pattern cutter 36.

As also shown schematically in FIG. 4, the granule patch conveyor 122 includes a continuous belt 140 having an upper flight 142 and a lower flight 144. The belt 140 travels around a first or forward roller 146 and a second or rear roller 148. The upper flight 142 of the granule patch conveyor 122 engages the lower flight 128 of the patch pattern belt assembly 120. In the illustrated embodiment, the upper flight 142 and the lower flight 128 are oriented at an acute angle A from a plane defined by the asphalt-coated sheet 20. In the illustrated embodiment, the angle A is about 5 degrees. Alternatively, the angle A is an angle within the range of from about 5 degrees to about 45 degrees. In another embodiment, the angle A is an angle within the range of from about 0 degrees to about 90 degrees.

The granule patch conveyor 122 is operated by a motor (not shown) which causes the continuous belt 140 to travel at near machine speed, or the speed of the moving asphalt-coated sheet 20.

The first granule applicator 22 includes means for supplying granules 150 to the interior space 130 of the patch pattern belt assembly 120. As shown schematically in FIG. 4, the first granule applicator 22 may include an auger 152 for moving granules 150 from a source of granules (not shown) to a hopper 154 within the interior space 130. Alternatively, granules 150 may be moved into the hopper 154 in the interior space 130 by other suitable means. For example, the granules 150 may be moved into the hopper 154 through a gravity-feed device, such as a chute or tube (not shown).

The granules 150 may then be fed from the hopper 154 by a fluted roll 156 from which upon rotation, the granules 150 are discharged into contact with a chute 158. The illustrated chute 158 is elongated and substantially flat, although the chute may have other shapes, such as a substantially curved cross-sectional shape. The chute 158 extends outwardly and in a down-stream direction. The chute 158 guides the granules 150 radially outwardly and downwardly from the fluted roll 156 and into each of the holes 138 in the continuous belt 124.

If desired, side guides or rails, schematically illustrated at 160 in FIG. 5, may be mounted within the interior space 130 to maintain the granules 150 within a granule patch lane GL, the width of which is defined by the height H of the holes 138.

It will be understood that the first granule applicator 22 described above is not required, and that other granule applicators may be provided. Examples of other suitable granule applicators include the embodiments of the blend drop application station disclosed in the concurrently filed U.S. patent application entitled “Apparatus and Method for Depositing Particles” (U.S. patent application Ser. No. ______) to David P. Aschenbeck. U.S. patent application Ser. No. ______ is commonly assigned, has the same inventor as the present application, and is incorporated herein by reference.

It will be further understood that the hopper 154 and fluted roll 156 described above are not required, and that any other desired granule dispenser may be provided within the interior space 130. Examples of other suitable granule dispensers include a hopper having a slide gate, and a vibratory feeder.

In operation, continuous belt 124 of the patch pattern belt assembly 120 is caused to move in a counter-clockwise direction and the continuous belt 140 of the granule patch conveyor 122 is caused to move in a clockwise direction when viewing FIG. 4.

The granules 150 may be selectively dispensed or discharged into the interior space 130. As used herein, the phrase “selectively dispensed or discharged” is defined as controlling the rate of flow of the granules 150 into the interior space 130 and/or controlling the axial position of the discharged granules 150 to ensure the granules 150 are discharged substantially onto the upper flight 142 of the granule patch conveyor 122 within each of the holes 138. For example, the rate of flow out of the granule dispenser 22 may be pre-calibrated and programmed to provide a desired pre-determined rate that may vary depending on the line-speed and/or the specific pattern of holes 138 formed in the continuous belt 124. The granules 150 that have been discharged onto the upper flight 142 of the granule patch conveyor and within the holes 138 therefore define the granule patches 74 to be applied to the asphalt-coated sheet 20.

Each granule patch 74 continues to travel on the upper flight 142. As the belt 140 turns around the forward roller 146, each granule patch 74 is released from contact with the belt 140. The granule patch 74 then moves forwardly and downwardly at near-sheet speed to the asphalt-coated sheet 20 along a path generally shown by the line P.

The present invention should not be considered limited to the specific examples described herein, but rather should be understood to cover all aspects of the invention. Various modifications, equivalent processes, as well as numerous structures and devices to which the present invention may be applicable will be readily apparent to those of skill in the art. Those skilled in the art will understand that various changes may be made without departing from the scope of the invention, which is not to be considered limited to what is described in the specification.

What is claimed is:

1. A method of making shingles having an overlay portion and an underlay portion, the method comprising:
establishing a continuous shingle overlay sheet having a repeated pattern of tabs and cutouts;
establishing a continuous shingle underlay sheet having a repeated pattern of granule patches;
sensing the presence of the pattern of tabs and cutouts on the continuous shingle overlay sheet;
sensing the presence of the pattern of granule patches on the continuous shingle underlay sheet;
synchronizing the position of the continuous shingle overlay sheet relative to the continuous shingle underlay sheet in response to the sensed presence of the repeated pattern of tabs and cutouts and the sensed presence of the repeated pattern of granule patches, such that each granule patch in the pattern of granule patches is aligned with one of the tabs in the pattern of tabs and cutouts;
laminating the continuous shingle overlay sheet to the continuous shingle underlay sheet to define a laminated sheet; and
cutting the laminated sheet into a plurality of shingles.

2. The method according to claim 1, further including the step of applying a timing mark to the continuous shingle underlay sheet, the timing mark indicating a period of the repeated pattern of granule patches.

3. The method according to claim 2, further including applying the timing mark within a patch of the repeated pattern of granule patches.

4. The method according to claim 2, further including applying the timing mark on a back surface of the continuous shingle underlay sheet.

5. The method according to claim 1, further including applying granules to the continuous shingle underlay sheet to define a shadow strip.

6. The method according to claim 5, further including the step of applying a timing mark within the shadow strip of the continuous shingle underlay sheet, the timing mark indicating a period of the repeated pattern of granule patches.

7. The method according to claim 1, wherein the continuous shingle overlay sheet and the continuous shingle underlay sheet are formed by cutting a single continuous granule-coated sheet.

8. The method according to claim 1, further including directing the continuous shingle underlay sheet along an underlay pathway, wherein the step of synchronizing the position of the continuous shingle overlay sheet is affected by modulating the length of the underlay pathway.

9. The method according to claim 8, wherein the step of synchronizing the position of the continuous shingle overlay sheet includes comparing a sensed beginning of the repeated pattern of tabs and cutouts and a sensed beginning of the repeated pattern of granule patches and generating an error signal indicative of the distance by which the beginning of the repeated pattern of tabs and cutouts is offset with respect to the beginning of the repeated pattern of granule patches, and modulating the length of the underlay pathway in response to the error signal.

10. The method according to claim 8, wherein the underlay pathway is configured to change directions around a roller, and the roller is moved to change the length of the underlay pathway to synchronize the position of the continuous shingle overlay sheet relative to the continuous shingle underlay sheet in response to the sensed presence of the repeated pattern of tabs and cutouts and the sensed presence of the repeated pattern of granule patches.

11. The method according to claim 1, wherein the shapes and sizes of the granule patches in the repeated pattern of granule patches correspond to the shapes and sizes of the repeated pattern of tabs and cutouts.

12. The method according to claim 1, wherein the step of establishing a continuous shingle underlay sheet includes:
applying first granules to the continuous shingle underlay sheet, the first granules defining the repeated pattern of granule patches, and wherein a portion of the continuous shingle underlay sheet not covered by the repeated pattern of granule patches defines a prime region of the continuous shingle underlay sheet; and
applying second granules to the remainder portion of the continuous shingle underlay sheet.

13. The method according to claim 12, wherein the first granules are headlap granules, and wherein the second granules are prime granules.

14. The method according to claim 1, wherein the step of laminating includes aligning each granule patch under a tab of the continuous shingle overlay sheet.

15. A method of making shingles having an overlay portion and an underlay portion, the method comprising:
establishing a continuous asphalt-coated sheet having a continuous underlay sheet portion and a continuous overlay sheet portion;
applying a repeated pattern of granule patches to the continuous underlay sheet portion;
forming a repeated pattern of tabs and cutouts in the continuous overlay sheet portion;
separating the continuous underlay sheet portion from the continuous overlay sheet portion to define a continuous shingle underlay sheet and a continuous shingle overlay sheet;
sensing the presence of the pattern of tabs and cutouts on the continuous shingle overlay sheet;
sensing the presence of the pattern of granule patches on the continuous shingle underlay sheet;
synchronizing the position of the continuous shingle overlay sheet relative to the continuous shingle underlay sheet in response to the sensed presence of the repeated pattern of tabs and cutouts and the sensed presence of the repeated pattern of granule patches, such that each granule patch in the pattern of granule patches is aligned with one of the tabs in the pattern of tabs and cutouts;
laminating the continuous shingle overlay sheet to the continuous shingle underlay sheet to define a laminated sheet; and
cutting the laminated sheet into a plurality of shingles.

16. The method according to claim 15, wherein the step of applying a repeated pattern of granule patches includes:
applying first granules to the continuous underlay sheet portion, the first granules defining the repeated pattern of granule patches, and wherein a portion of the continuous underlay sheet portion not covered by the repeated pattern of granule patches defines a prime region of the continuous underlay sheet portion; and
applying second granules to the remainder portion of the continuous underlay sheet portion.

17. The method according to claim 15, wherein the first granules are headlap granules, and wherein the second granules are prime granules.

18. The method according to claim 15, wherein the step of laminating includes aligning each granule patch under a tab of the continuous shingle overlay sheet.

19. The method according to claim 15, further including the step of applying a timing mark to the continuous underlay sheet portion, the timing mark indicating a period of the repeated pattern of granule patches.

20. The method according to claim 19, further including applying the timing mark within a patch of the repeated pattern of granule patches.

21. The method according to claim 19, further including applying the timing mark on a back surface of the continuous underlay sheet portion.

22. The method according to claim 15, further including applying granules to the continuous underlay sheet portion to define a shadow strip.

23. The method according to claim 22, further including the step of applying a timing mark within the shadow strip of the continuous underlay sheet portion, the timing mark indicating a period of the repeated pattern of granule patches.
